(19) United States
(12) Patent Application Publication
(10) Pub. No.: US 2007/0234972 A1
(43) Pub. Date: Oct. 11, 2007

(54) Wheel dog harness

(76) Inventor: Ivana Nolke, Salcha, AK (US)

Correspondence Address: Ivana Nolke, 5845 Old Valdez Trail, Salcha, AK, 99714, US

(21) Appl. No.: 11/401,540

(22) Filed: Apr. 10, 2006

(51) Int. Cl. A01K 27/00

(52) U.S. Cl. 119/856

(57) ABSTRACT

This invention is a unique sled dog harness that relives pressure on the dogs lower back and hips. The harness will minimize injuries that commonly occur in sled dogs. A metal ring sewn into each side of the harness allows the rear section of the harness to move up and down as the dog runs. Although this invention is called the Wheel Dog Harness (dogs immediately in front of the sled), the harness can be used on any dog in any position in the dog team with the same beneficial results.

### BACKGROUND OF THE INVENTION

This invention relates to a harness for dogs used for pulling a sled or other conveyance. In the case of working dogs trained for pulling, special factors must be taken into consideration with respect to a suitable harness design. A typical pulling harness will reach from the dog's neck to the end of a dog's body where the dog's tail is attached. Such a harness is called either an “X-back” or “H-back”, depending on how the harness straps from the neck opening to the posterior end of the harness are configured (an example of such a harness is U.S. Pat. No 5,937,794). When the working dog is using either of these two types of harnesses to pull a sled or other conveyance, the harness causes a downward pressure on the dog's back, often resulting in lower back injuries. Any undue pressure on the dog's lower back muscles, spine or nerves can cause both chronic and acute injuries to the dog.

It is accordingly an object of the present invention to provide an improved harness for sled dogs.

It is another object of this invention to provide a sled dog harness, which does not apply any pressure on the dog's lower back.

It is a further object of this invention to provide a harness of the aforesaid nature, which is comfortable to the sled dog.

It is a further object of the present invention to provide a harness of the aforesaid nature, which is quickly and easily deployed upon a sled dog.

It is yet another object of the present invention to provide a harness of the aforesaid nature, which is durable and simple in construction.

### BRIEF SUMMARY OF THE INVENTION

This invention relates to the Wheel Dog Harness, whose construct is made up of the following components:
a) A piece of nylon webbing sewn together to form an opening (neck yoke) that fits over the dog's head. Two body straps made of nylon webbing are attached to the bottom of the neck yoke and run down under the dog's front legs and chest and along the side of the dog's body, continuing on to a point at the rear of the dog where their ends meet and form the end of the harness. This is the point of attachment to which lines or traces are connected and allows the dog to pull the sled or other conveyance. Additionally, two nylon webbing back straps attach to the neck yoke behind the head and run partway across the back and attach at a mid-point along the two body straps. The two body straps are held together by an X-shaped piece of nylon webbing that rests on the dog's back and holds the harness in place on the dog's body.
b) The two body straps have a metal ring sewn into the webbing in the area of the dog's groin. Such a unique construction enables the end section of the harness (from the ring to the back end of the harness) to move independently of the fixed front section of the harness while a dog is in motion. A dog's motion while running is typically a rocking up and down with the dog's head and rear end alternating between this up and down motion. The metal rings in the body straps allow the rear section of the harness to pivot when the dog's rear moves into the up position and likewise to move down when the dog's rear rocks into the down position. Standard harness designs that extend only to the tailbone of the dog put pressure on the dog's rear when dog's rear locks into the up position, potentially causing injuries to the dog.
c) soft padding made out of lightweight foam covered in rip-stop nylon shell extends from the neck yoke along the harnesses's entire length. This padding prevents excessive rubbing on the dog's chest and body.

### BRIEF DESCRIPTION OF THE DRAWINGS

For a fuller understanding of the nature and objects of the invention, reference should be made to the figures provided. Similar numerals of reference indicate corresponding parts in all the figures of the drawing:

FIG. 1: View of Wheel Dog Harness fitted on a dog.

FIG. 2: Orthographic views of Wheel Dog Harness (side view, front view and top view).

### NUMBER DESCRIPTION LIST:

1: Body strap
2: Ring which allows rear harness section to pivot
3: Rear section of harness
4: Point of attachment for hooking up dog harness to lines
5: X-shaped webbing
6: Neck yoke
7: Point of attachment of body straps
8: Back strap webbing
9: Point of attachment of back straps to neck yoke
10: Point of attachment of back straps to body straps
11: Point of attachment of X-back strap to body strap
12: Point of attachment of X-back strap to back strap

### DETAILED DESCRIPTION OF THE INVENTION

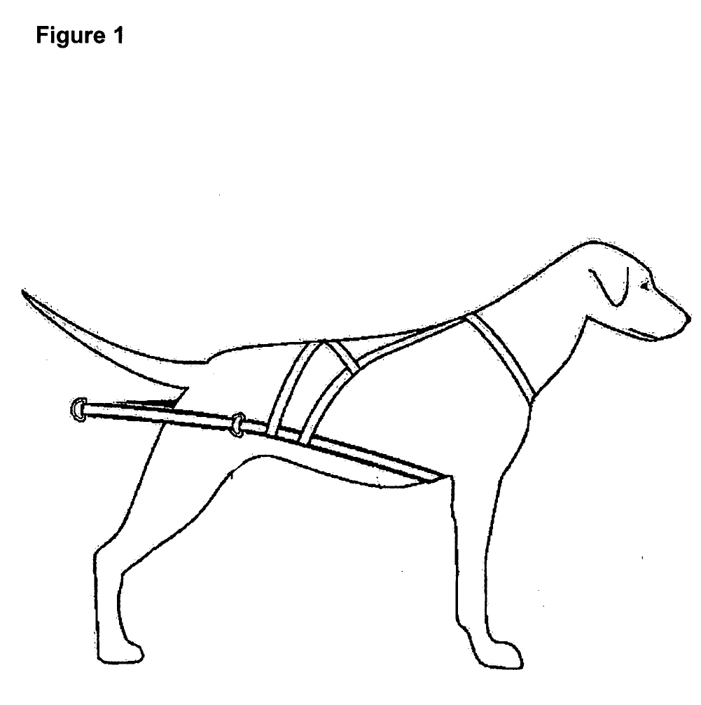

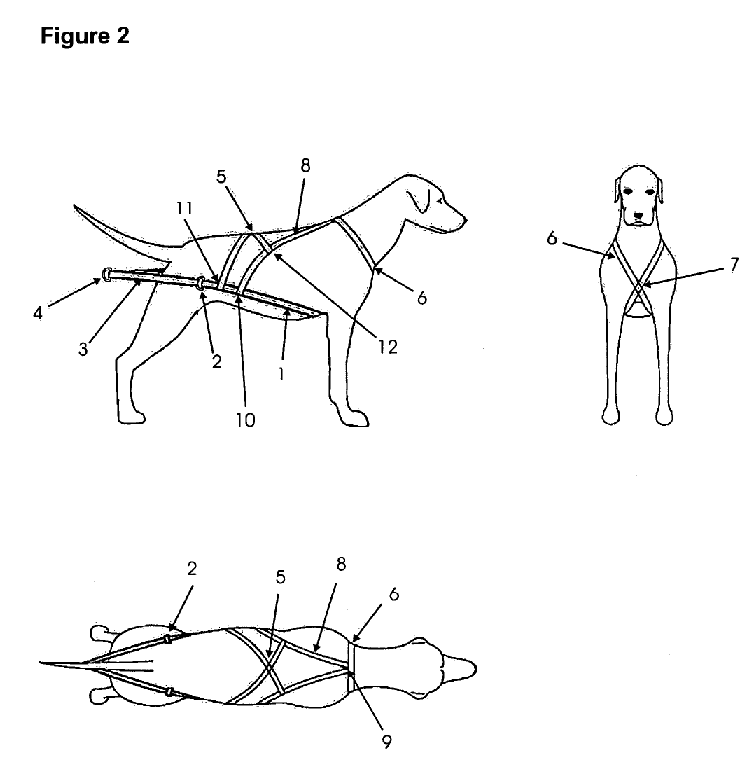

FIG. 1 is an illustration of the Wheel Dog Harness properly fitted on a dog. The wheel dog harness is used by working dogs that are pulling a sled or other conveyance. FIG. 2 provides an illustration of the harness components. The harness consists of a nylon webbing neck yoke 6, to which are attached two nylon webbing body straps 1, at location 7. These two body straps extend to the rear end of the dog where they are attached together at 4. Two additional pieces of nylon webbing 8 are attached to the neck yoke behind the head at 9. These back straps extend down the back and attach to the body straps at 10. An X-shaped piece of nylon webbing 5 is attached to both the back straps at 12 and the body straps at 11. The nylon webbing body straps are attached to a metal ring at 2, with an additional length of nylon webbing extending from this ring to the back end of the harness where the two body straps are attached together. The portion of the harness 3 is the movable tailpiece of the Wheel Dog Harness.

The neck yoke and the body straps have soft padding made out of lightweight foam covered in rip-stop nylon shell for their entire length. The nylon webbing is attached to the metal rings by looping the end of the webbing over on itself and stitching it together. All other components of the harness are stitched together with an industrial sewing machine.

The Wheel Dog Harness is custom made to fit a specific sized dog. The harness is made in a wide range of sizes so that the harness can fit snugly on a given dog. Harnesses are made in extra-small, small, medium, large, extra-large, and double extra-large. Properly fitting a dog with the correct size harness is extremely important.

What is claimed is:

1. A harness designed to relieve the pressure that normally occurs on a dog's hips and lower back that occurs when standard sled dog harnesses are used. This harness design eliminates lower back injuries in sleddogs. The use of the Wheel Dog Harness will free the dog's pelvis and result in an easier and more comfortable body movement. The harness will also allow the dog to have a straighter smoother gait, resulting in fewer injuries to the dog's shoulders and wrists. The Wheel Dog Harness design is superior to any pulling harness currently available on the market today.
